(19) United States
(12) Patent Application Publication
(10) Pub. No.: US 2008/0224816 A1
(43) Pub. Date: Sep. 18, 2008

(54) ELECTROSTATIC DISCHARGE PROTECTION COMPONENT, AND ELECTRONIC COMPONENT MODULE USING THE SAME

(76) Inventors: Tatsuya INOUE, Osaka (JP); Hidenori KATSUMURA, Hyogo (JP); Masaaki HAYAMA, Nara (JP)

Correspondence Address: MCDERMOTT WILL & EMERY LLP, 600 13TH STREET, NW, WASHINGTON, DC, 20005-3096, US

(21) Appl. No.: 12/047,914

(22) Filed: Mar. 13, 2008

(30) Foreign Application Priority Data
Mar. 13, 2007 (JP) 2007-063198
Apr. 17, 2007 (JP) 2007-107943

(51) Int. Cl. H01C 7/10

(52) U.S. Cl. 338/21

(57) ABSTRACT

An electrostatic discharge protection component comprises a ceramic sintered body having ceramic substrate 12, varistor portion 10 formed thereon, and glass ceramic layer 14 formed further thereon, a pair of terminal electrodes 13a, 13b provided on the surface of this ceramic sintered body, a pair of external electrodes 16a, 16b, and heat conducting portion 15 penetrating through the ceramic sintered body vertically, and therefore by mounting the light-emitting diode on heat conducting portion 15 of this electrostatic discharge protection component, the size is reduced, and the heat generated from the component may be released efficiently.

### BACKGROUND OF THE INVENTION

1. Field of the Invention

The present invention relates to an electrostatic discharge protection component (hereinafter referred to simply as protection component) which protects an electronic device from electrostatic discharge, and an electronic component module using the same such as a light-emitting diode module.

2. Background Art

Recently, electronic equipment such as a mobile phone and the like is rapidly reduced in size and power consumption, and accordingly, the withstand voltages of various types of electronic component which configure the circuit of electronic equipment are becoming lower.

As a result, troubles increasingly occur in electronic equipment due to breakdown of electronic components, semiconductor devices in particular, caused by electrostatic discharge pulses generated when human body comes in contact with a conductive part of electronic equipment.

Also, with the advance of white blue diodes, a light-emitting diode which is a kind of semiconductor device is expected to be widely used for the back light of a display device or the flash of a small camera. However, such a white blue diode is low in the withstand voltage against electrostatic discharge pulses, giving rise to the occurrence of a problem.

A conventional countermeasure against such electrostatic discharge pulses is to provide an electronic component having non-linear resistance characteristic such as varistor and Zener diode between the incoming line of electrostatic discharge and the ground so as to bypass the electrostatic discharge pulse to the ground, thereby reducing the high voltage applied to the light emitting diode.

An example of conventional technology for protecting a light-emitting diode from electrostatic discharge pulses by using a varistor or Zener diode is disclosed in Japanese Patent Unexamined Publication No. 2002-335012.

However, in such a conventional configuration wherein a light-emitting diode is combined with a varistor or Zener diode, the light-emitting diode is just connected to the varistor or Zener diode via another member such as a substrate, which is not integrated and therefore difficult to be reduced in size.

Also, it is necessary to apply greater current in order to enhance the light emission of the light-emitting diode. However, as the current applied becomes greater, the light-emitting diode itself generates heat. And, due to the heat, the light-emitting diode is deteriorated, and it invites such a result that the light emitting efficiency is lowered and the life becomes shorter. Accordingly, in order to prevent lowering of the light emitting efficiency and shortening of the life of the light-emitting diode, it is necessary to efficiently release such heat generated by the light-emitting diode. However, in the case of a chip type which is a relatively small-sized package, it is difficult to efficiently release heat generated by a light-emitting diode because of having no heat dissipation mechanism and using resin for facing.

### SUMMARY OF THE INVENTION

The present invention is intended to solve the above problem, and the object of the invention is to provide a protection component which is small and strong being excellent in heat dissipation, and an electronic component module using the same.

In order to achieve the above purpose, the protection component of the present invention comprises a ceramic sintered body having a ceramic substrate, a varistor portion formed by laminating a varistor layer and an internal electrode alternately on the ceramic substrate, and a glass ceramic layer formed on the varistor portion, a par of terminal electrodes provided on the ceramic sintered body, a pair of external electrodes connected to the internal electrode and the terminal electrodes, and a heat conducting portion penetrating through the ceramic sintered body.

The electronic component module of the present invention is manufactured by mounting an electronic component element on a heat conducting portion of the protection component, and connecting a terminal of the electronic component element and a terminal electrode of the protection component electrically.

By using the protection component of the present invention, a protection component of small size and high strength incorporating a varistor function is realized.

When a light-emitting diode or other electronic component element is used and mounted, since the heat conducting portion is provided, the heat generated from the mounted component can be released efficiently.

According to the electronic component module of the present invention, since the electronic component element is protected from the electrostatic discharge pulses by the varistor portion of the protection component, the resistance to electrostatic discharge pulses is excellent.

Since the heat generated by the electronic component element can be efficiently released by the heat conducting portion, a small and practical electronic component module excellent in heat releasing performance and high in light emission efficiency may be realized.

### BRIEF DESCRIPTION OF THE DRAWINGS

FIG. 1 is a perspective outline view of a protection component in exemplary embodiment 1 of the present invention.

FIG. 2 is a sectional view along line 2-2 of the protection component in exemplary embodiment 1.

FIG. 3 is a sectional view along line 3-3 of the protection component in exemplary embodiment 1.

FIG. 4 is a schematic perspective exploded view of the protection component in exemplary embodiment 1.

FIG. 5 is a sectional view of an protection component module in exemplary embodiment 1 of the present invention.

FIG. 6 is an equivalent circuit diagram of the electronic component module.

FIG. 7 is a schematic perspective exploded view of a protection component in a comparative example.

FIG. 8 is a perspective outline view of a protection component in a comparative example.

FIG. 9 is a sectional view of an electronic component module in a comparative example.

FIG. 10 is a sectional view for explaining an evaluating method of dissipation performance of the electronic component module in exemplary embodiment 1.

FIG. 11 is a sectional view for explaining an evaluating method of dissipation performance of an electronic component module in a comparative example.

FIG. 12 is a sectional view of a protection component in other example of exemplary embodiment 1.

FIG. 13 is a sectional view of an electronic component module in other example of exemplary embodiment 1.

FIG. 14 is a sectional view of a protection component in another example of exemplary embodiment 1.

FIG. 15 is a sectional view of an electronic component module in another example of exemplary embodiment 1.

FIG. 16 is a perspective outline view of a protection component in exemplary embodiment 2 of the present invention.

FIG. 17 is a sectional view along line 17-17 of the protection component.

FIG. 18 is a sectional view along line 18-18 of the protection component.

FIG. 19 is a schematic perspective exploded view of the protection component.

FIG. 20 is a sectional view of an electronic component module in exemplary embodiment 2 of the present invention.

FIG. 21 is a sectional view for explaining an evaluating method of dissipation performance of an electronic component module.

FIG. 22 is a sectional view of a protection component in other example of exemplary embodiment 2.

FIG. 23 is a sectional view of an electronic component module in other example of exemplary embodiment 2.

### DETAILED DESCRIPTION OF THE INVENTION

The best modes for carrying out the present invention are described below while referring to the accompanying drawings. In the following exemplary embodiments, as an example of electronic component module, a light-emitting diode module using a light-emitting diode as an electronic component element is explained.

### Exemplary Embodiment 1

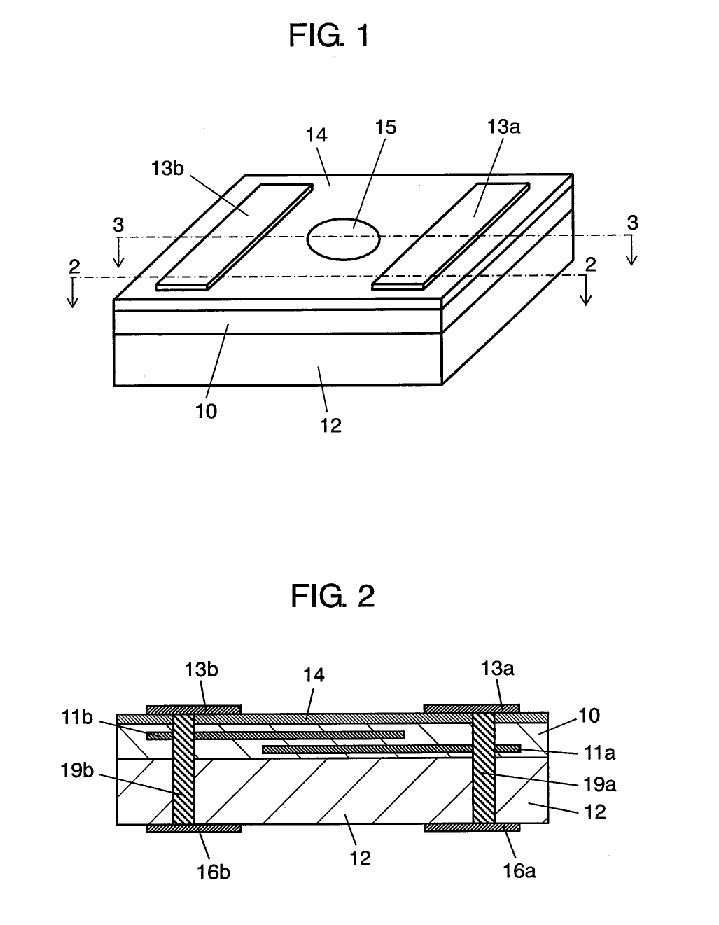

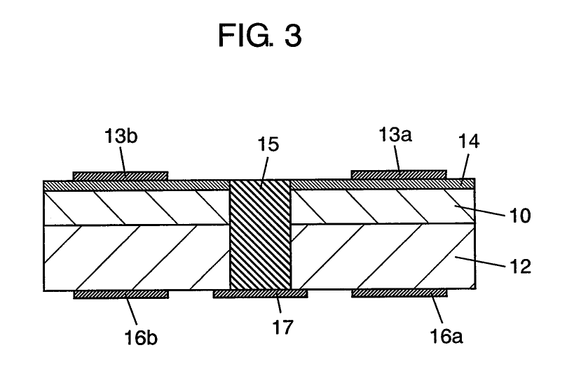

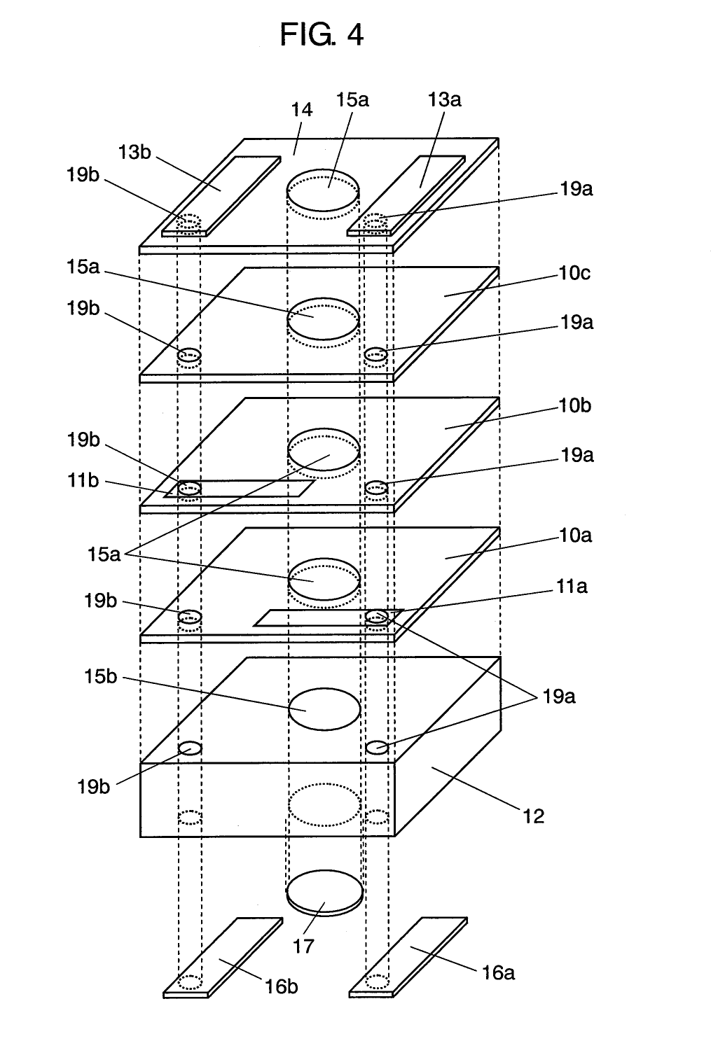

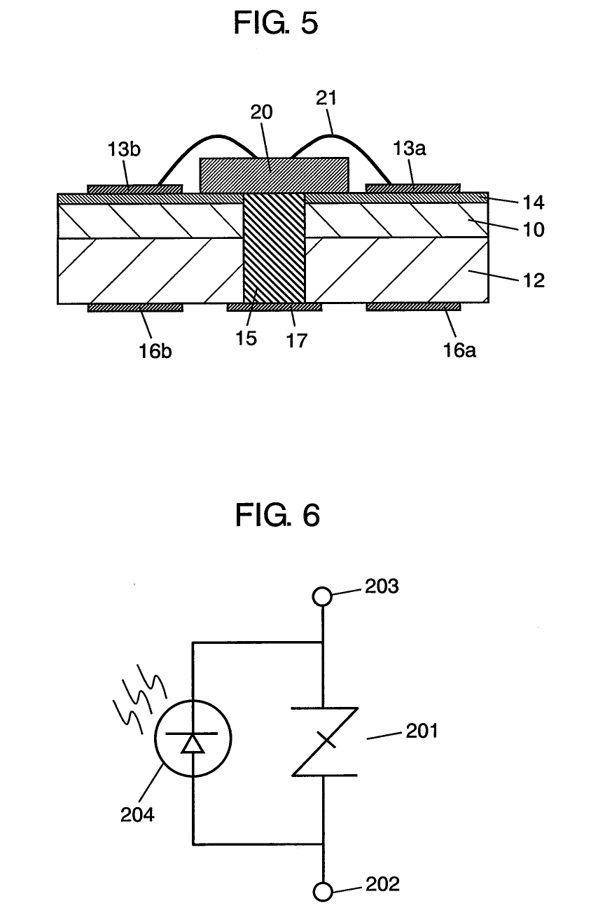

An protection component and a light-emitting diode module in exemplary embodiment 1 of the present invention are described. FIG. 1 is a perspective outline view of a protection component in the exemplary embodiment of the present invention. FIG. 2 is a sectional view along line 2-2′ of the protection component in the exemplary embodiment. FIG. 3 is a sectional view along line 3-3 of the protection component in the exemplary embodiment. FIG. 4 is a schematic perspective exploded view of the protection component in the exemplary embodiment. FIG. 5 is a sectional view of a light-emitting diode module in the exemplary embodiment. FIG. 6 is an equivalent circuit diagram of the light-emitting diode module in the exemplary embodiment.

As shown in FIGS. 1 to 4, the protection component in the exemplary embodiment has varistor portion 10 having three varistor layers 10a, 10b, and 10c, and internal electrodes 11a and 11b laminated alternately. It also has a ceramic sintered body having ceramic substrate 12, varistor portion 10 formed on this ceramic substrate 12, and glass ceramic layer 14 laminated and formed thereon. On the surface of glass ceramic layer 14 of the ceramic sintered body, a pair of terminal electrodes 13a and 13b are provided. On the opposite side of the forming side of terminal electrodes 13a and 13b of the ceramic sintered body, a pair of external electrodes 16a and 16b are provided. Heat conducting portion 15 is further provided to penetrate through the ceramic sintered body vertically, and external heat conducting portion 17 is provided at the underside of the ceramic sintered body to be connected to heat conducting portion 15. Internal electrode 11a is electrically connected to external electrode 16a and terminal electrode 13a by way of via conductor 19a for connection. Similarly, internal electrode 11b is electrically connected to external electrode 16b and terminal electrode 13b by way of via conductor 19b for connection. When a light-emitting diode or other electronic component element is mounted on the protection component in the exemplary embodiment, heat conducting portion 15 on the upside of the ceramic sintered body is used as a mounting area for the electronic component element. Terminal electrodes 13a and 13b are electric connecting areas with the electronic component element.

As shown in FIG. 5, in the light-emitting diode module in the exemplary embodiment, light-emitting diode 20 is mounted on heat conducting portion 15 of the protection component. By using metal wire 21, one terminal of light-emitting diode 20 is electrically connected to terminal electrode 13a of the protection component, and other terminal is electrically connected to terminal electrode 13b.

Therefore, the light-emitting diode module circuit in the exemplary embodiment is an equivalent circuit shown in FIG. 6. In FIG. 6, light-emitting diode 204 is connected parallel to external electrodes 202 and 203 of varistor 201 formed of internal electrodes 11a and 11b and varistor layer 10b as explained above.

As described herein, the protection component in the exemplary embodiment is composed by forming heat conducting portion 15 penetrating through the ceramic sintered body, on this ceramic sintered body formed integrally by laminating and sintering varistor portion 10 and glass ceramic layer 14 on ceramic substrate 12.

In the light-emitting diode module in the exemplary embodiment, light-emitting diode 20 is mounted on heat conducting portion 15 at the upside of the ceramic sintered body.

Therefore, by using heat conducting portion 15 of high heat conductivity, the heat generated from the mounted component may be released efficiently.

Further, by forming external heat conducting portion 17 to be connected to heat conducting portion 15 at the underside of the ceramic sintered body, the adhesion of the connection part mounted and connected on an external cooling plate or the like may be enhanced, and the heat generated from the mounted light-emitting diode may be released more effectively.

A manufacturing method of the protection component in the exemplary embodiment is explained by referring to FIG. 4.

A zinc oxide green sheet is prepared by using ceramic powder mainly composed of zinc oxide and an organic binder. A glass-ceramic green sheet is prepared by using glass-ceramic powder mainly composed of alumina and borosilicate glass, and an organic binder. At this time, the thickness of these green sheets was about 30 μm. The green sheets are baked, and varistor portion 10 is produced from the zinc oxide green sheet, and glass ceramic layer 14 is produced from the glass-ceramic green sheet.

As shown in FIG. 4, at the positions of via conductors for connection 19a and 19b, respectively for the zinc oxide green sheet for varistor layers 10a, 10b, 10c, and the glass-ceramic green sheet for glass ceramic layer 14, through-holes were formed by using a puncher or the like, and the through-holes were filled with silver paste. On the zinc oxide green sheet for varistor layer 10a, a conductor layer was formed as internal electrode 11a by using silver paste by screen printing method. Further thereon, a conductor layer was formed as internal electrode 11b by using silver paste by screen printing method, and the zinc oxide green sheet was laminated as varistor layer 10b. Further thereon, the zinc oxide green sheet was laminated as varistor layer 10c, and a laminated body was fabricated as varistor portion 10. Further thereon, conductor layers were formed as terminal elements 13a and 13b by using silver paste by screen printing method, and the glass-ceramic green sheet was laminated as glass ceramic layer 14. In this manner, a laminated body consisting of varistor portion 10 and glass ceramic layer 14 was fabricated. At this time, the conductor layers for forming internal electrodes 11a, 11b, and the conductor layers for forming terminal electrodes 13a, 13b were formed by avoiding an area for forming heat conducting portion 15a in a later process as shown in FIG. 4. The through-hole for forming via conductor for connection 19a was provided at a position for connecting with the conductor layer for forming internal electrode 11a and the conductor layer for forming terminal electrode 13a. Similarly, the through-hole for forming via conductor for connection 19b was provided at a position for connecting with the conductor layer for forming internal electrode 11b and the conductor layer for forming terminal electrode 13b.

Consequently, a through-hole was formed by a puncher or the like to penetrate through varistor portion 10 and glass ceramic layer 14 of this laminated body, and the through-hole was filled with silver paste. This silver paste applied in the through-hole becomes heat conducting portion 15a after baking.

On the other hand, as ceramic substrate 12, an alumina substrate having through-holes provided at three specified positions was prepared, and the through-holes in the alumina substrate were filled with silver paste. Further, on one side of the alumina substrate, conductor layers for forming external heat conducting portion 17 and external electrodes 16a and 16b were formed by using silver paste by screen printing method. The silver paste applied in the three through-holes becomes heat conducting portion 15b and via conductors for connection 19a and 19b after baking. Heat conducting portion 15b is integrated with heat conducting portion 15a of the laminated body after baking, and heat conducting portion 15 is formed. Via conductor for connection 19a is integrated with via conductor for connection 19a of the laminated body after baking, and via conductor for connection 19b is integrated with via conductor for connection 19b of the laminated body after baking.

On the alumina substrate having through-holes filled with silver paste and formed with the conductor layer, a laminated body of varistor portion 10 and glass ceramic layer 14 filling the through-holes with silver paste was adhered, and a laminated body block was formed. The thickness of the alumina substrate was about 180 μm, and the thickness of the conductor layer was about 2.5 μm. The silver content of the silver paste used in the heat conducting portion was 85 wt. %, the diameter of the heat conducting portion was 300 microns, and the diameter of the via conductor for connection was 100 microns. The pattern of the printed conductor layer was formed of a multiplicity of vertical and lateral shapes arranged so as to be as shown in FIG. 4 after being cut.

The laminated body block was heated in atmosphere to remove the binder, and was further heated up to 930° C. and baked in atmosphere, and an integrated sintered body was obtained. In succession, the positions of the external electrodes 16a, 16b and terminal electrodes 13a, 13b were plated with nickel and gold, and the sintered body of the laminated body block was cut and separated into individual pieces in specified dimensions, and the protection component conforming to the exemplary embodiment was obtained as shown in FIGS. 1 to 3.

The manufactured protection component in the exemplary embodiment was about 2.0 mm in length, about 1.25 mm in width, and about 0.3 mm in thickness. Varistor voltage V_{1mA} between external electrodes 16a and 16b, that is, the voltage in flow of current of 1 mA was 27 V.

In the manufacturing method of the exemplary embodiment, as explained in the method of forming terminal electrodes 13a, 13b, external electrodes 16a, 16b, and external heat conducting portion 17, when forming varistor portion 10 and glass ceramic layer 14 on the alumina substrate, they were baked simultaneously. Instead, for example, a sintered body is formed in the first place by disposing varistor portion 10, glass ceramic layer 14, heat conducting portion 15, and via conductors for connection 19a and 19b on the alumina substrate. Then, the conductor layer of silver paste for forming terminal electrodes 13a and 13b is formed on glass ceramic layer 14, and the conductor layer of silver paste for forming external electrodes 16a, 16b and external conductor part 17 is formed on one side of alumina substrate 12, and they are baked. Subsequently, terminal electrodes 13a, 13b, external electrodes 16a, 16b, and external heat conducting portion 17 may be formed. It is allowable to follow such steps. In the case of such process, the sintered body may be either a block of a multiplicity of vertical and lateral pieces arranged, or an individual sintered body, but it is preferred to use a block of sintered bodies from the viewpoint of production performance.

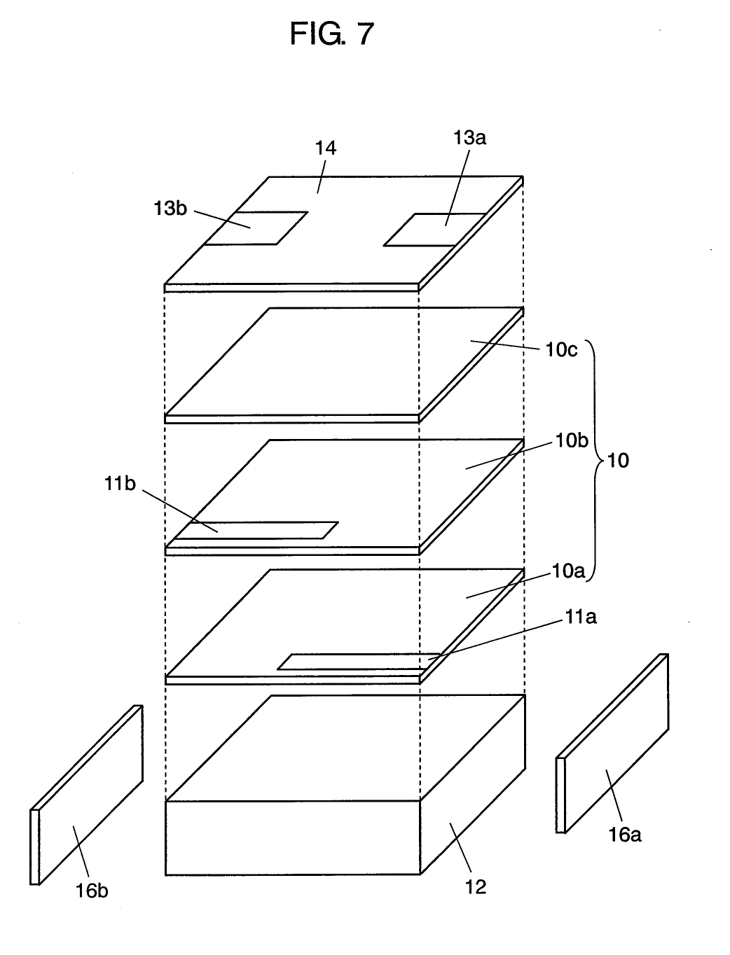

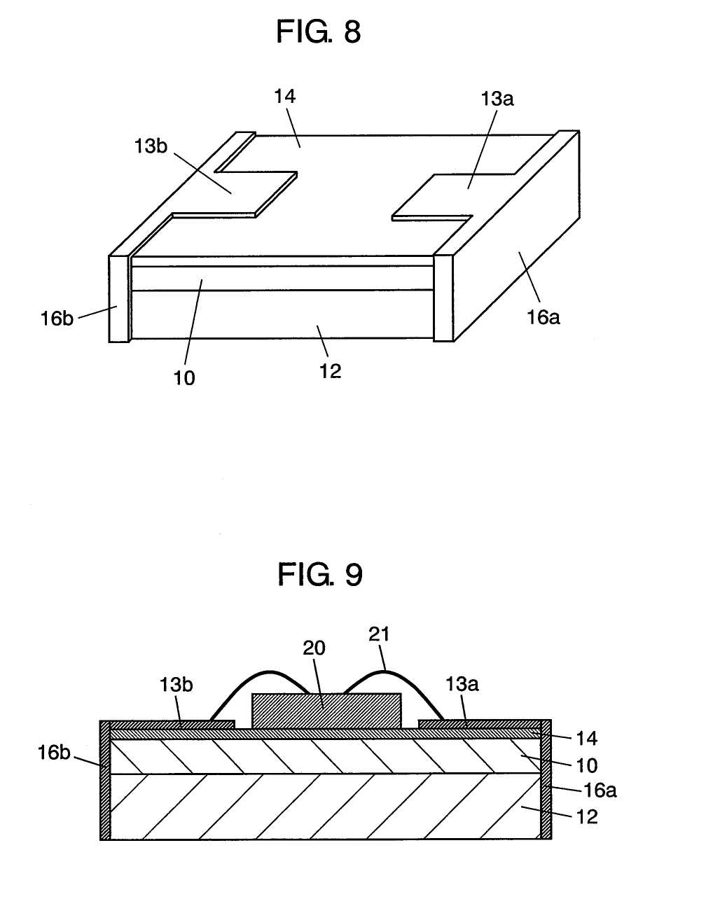

To compare with the exemplary embodiment, a comparative example of protection component was fabricated. Its schematic perspective exploded view is shown in FIG. 7, and its perspective outline view is shown in FIG. 8. What the protection component of the comparative example differs from the protection component of the exemplary embodiment lies in that heat conducting portion 15 and external heat conducting portion 17 are not provided, and that the external electrodes are disposed at the side face.

Referring now to FIG. 5, a manufacturing method of light-emitting diode module in an exemplary embodiment of the present invention is explained.

On heat conducting portion 15 of the protection component in the exemplary embodiment, blue light-emitting diode 20 is mounted by die-bonding by using a conductive adhesive (not shown). Then, by wire bonding method, one terminal of blue light-emitting diode 20 and terminal electrode 13a are connected by means of metal wire 21, and other terminal of blue light-emitting diode 20 and terminal electrode 13b are connected by means of metal wire 21. Blue light-emitting diode 20 was covered with resin mold (not shown), and a light-emitting diode module of the exemplary embodiment was manufactured as shown in FIG. 5.

To compare with the exemplary embodiment, using the protection component of the comparative example, a blue light-emitting diode element was mounted on the protection component of the comparative example, and a light-emitting diode module of the comparative example was manufactured. FIG. 9 is a sectional view of the light-emitting diode module of the comparative example. As shown in FIG. 9, the light-emitting diode module of the comparative example does not have heat conducting portion 15 and external heat conducting portion 17 penetrating through the ceramic sintered body, and external electrodes 16a and 16b are disposed at the side face of the ceramic sintered body.

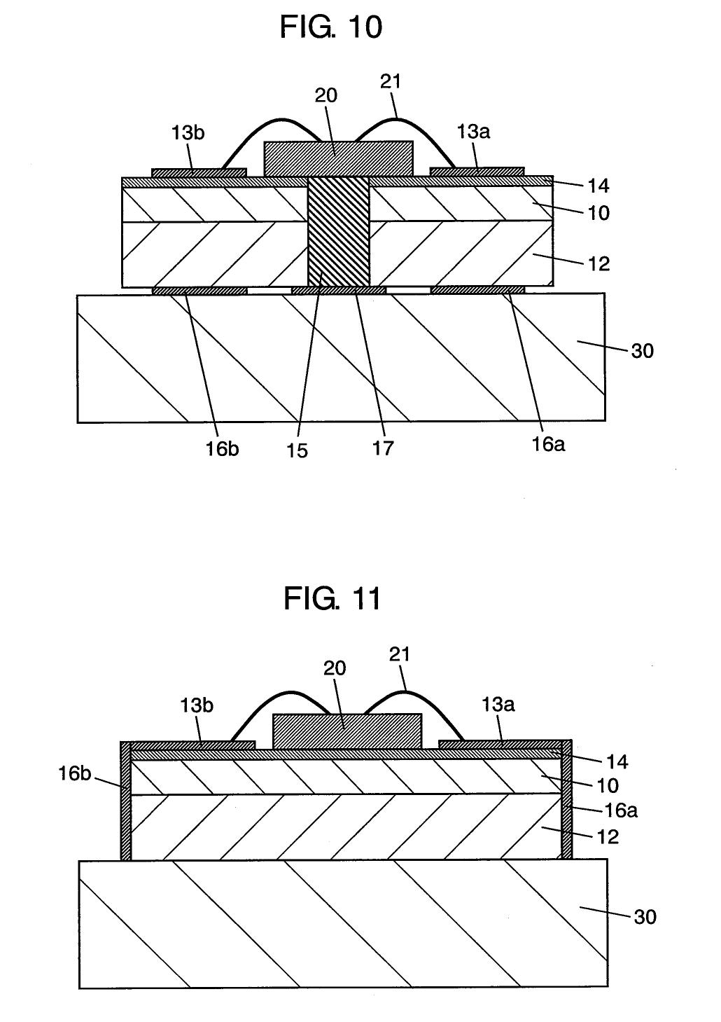

In the light-emitting diode module of the exemplary embodiment and the light-emitting diode module of the comparative example, the heat releasing performance was evaluated in the following procedure. Using these light-emitting diode modules, the light-emitting diode module was mounted on cooling plate 30 as shown in FIG. 10 in the case of the exemplary embodiment, and as shown in FIG. 11 in the case of the comparative example. Although not shown, the surface of cooling plate 30 was insulated at least the area except for the grounding side, out of the portions contacting with external electrodes 16a and 16b, and is provided with wiring for supplying electric power.

In each blue light-emitting diode 20, the diode was illuminated by applying an electric power of 1 W, and the electric power was supplied continuously until the temperature of blue light-emitting diode 20 was saturated. At this time, the temperature of blue light-emitting diode 20 was about 100° C. in the light-emitting diode module of the comparative example, and was about 85° C. in the light-emitting diode module of the exemplary embodiment.

Thus, the light-emitting diode module in exemplary embodiment 1 is known to be superior in dissipation performance as compared with the light-emitting diode module of the comparative example.

Incidentally, when the temperature of blue light-emitting diode 20 was saturated, the light intensity was measured in both samples, and supposing the light intensity ratio of the light-emitting diode module of the comparative example to be 100, the light intensity ratio of the light-emitting diode module of the exemplary embodiment was about 110. Hence, since the light-emitting diode module of the exemplary embodiment is superior in dissipation performance, it is known that decline of emission efficiency of the light-emitting diode can be prevented.

In the protection component and the light-emitting diode module of the exemplary embodiment, since external electrodes 16a and 16b are provided at the opposite side of the forming side of terminal electrodes 13a and 13b, as compared with the protection component and the light-emitting diode module of the comparative example, the mounting area on the wiring substrate or the like is smaller.

In the protection component of the comparative example, the external electrodes 16a and 16b are formed on the side face, and in the manufacturing process, the external electrodes 16a and 16b must be installed after cutting the element into individual pieces. Therefore, plating of external electrodes 16a and 16b and mounting of light-emitting diode element must be done separately in individual pieces.

By contrast, in the protection component of the exemplary embodiment, all of the internal electrodes 11a, 11b, external electrodes 16a, 16b, and terminal electrodes 13a, 13b may be formed by screen printing method, and the external electrodes 16a and 16b are formed before the element is cut into individual pieces. Therefore, the external electrodes 16a and 16b may be plated before being cut into individual pieces, and the manufacturing process is simplified, and lowered in cost.

It is further possible to install and mount light-emitting diodes and other electronic component elements before the individual cutting process, and the light-emitting diode module may be manufactured by the subsequent individual cutting process, so that the manufacturing process of light-emitting diode module is simplified, and lowered in cost.

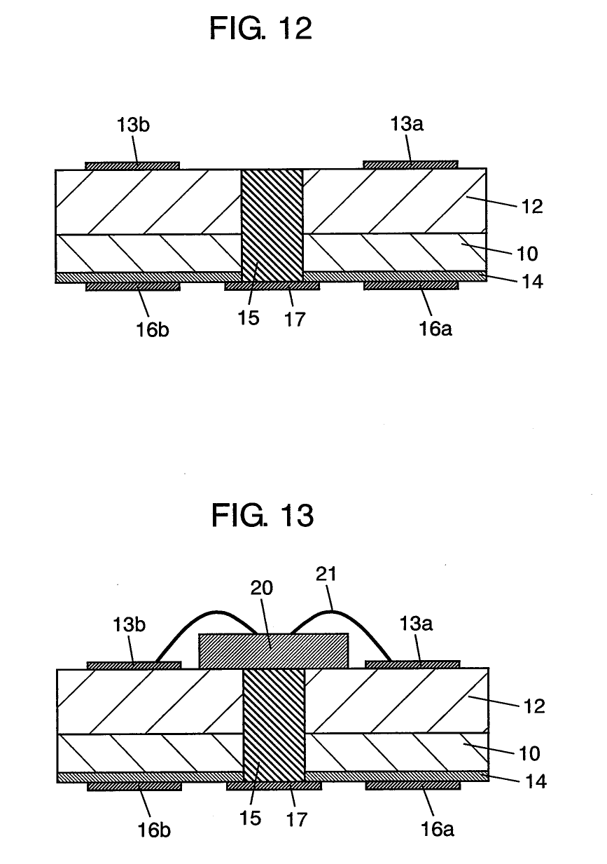

In the protection component of the exemplary embodiment, the terminal electrodes 13a and 13b are disposed on the surface of the glass ceramic layer 14 of the ceramic sintered body, but in the protection component in other example (called second example) of the exemplary embodiment, as shown in FIG. 12, terminal electrodes 13a and 13b may be provided on the surface at the opposite side of glass ceramic layer 14 of the ceramic sintered body. FIG. 13 is a sectional view of the light-emitting diode module using the protection component of this second example. In the protection component and light-emitting diode module of the second example, the same effects as in the exemplary embodiment are obtained.

In addition, by using a white substrate of alumina or the like as ceramic substrate 12, when the light-emitting diode is mounted, since the surrounding of the light-emitting diode is a white color high in reflectivity, the emission efficiency of the light-emitting diode may be further enhanced.

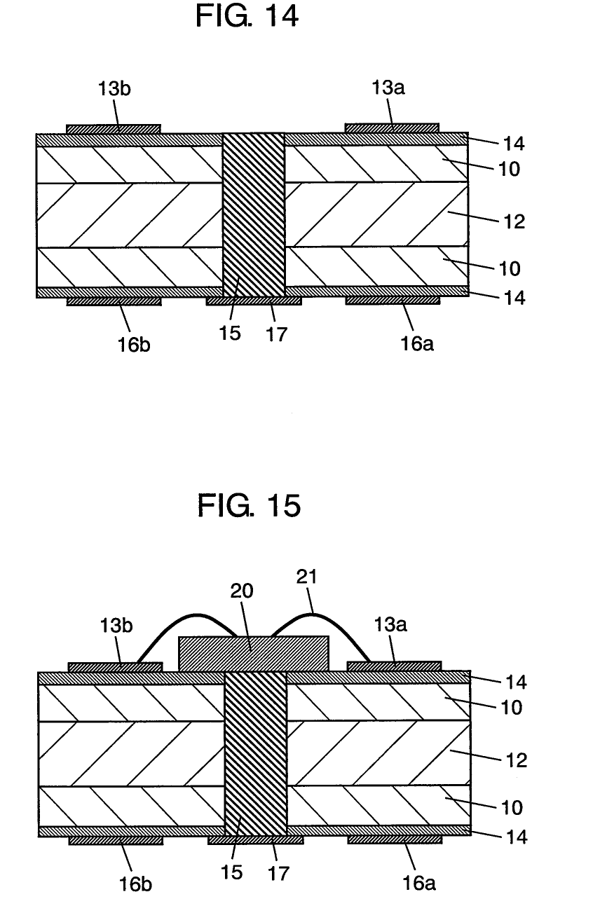

In the protection component of exemplary embodiment 1, varistor layer 10 and glass ceramic layer 14 are provided only on either side of ceramic substrate 12. But in the protection component in another example (called third example) of the exemplary embodiment, as shown in FIG. 14, varistor layer 10 and glass ceramic layer 14 may be provided on both sides of ceramic substrate 12. FIG. 15 is a sectional view of the light-emitting diode module using the protection component of this third example. In the protection component and light-emitting diode module of the third example, the same effects as in exemplary embodiment 1 are obtained.

In addition, by forming varistor layer 10 on both sides of ceramic substrate 12, the electrostatic capacity is increased, and it is easier to add a function as noise filter like bypass capacitor making use of its capacitance characteristics. Besides, the material composition is symmetrical vertically, slight warp or distortion due to difference in thermal shrinkage of constituent materials hardly occurs, and the adhesion to the cooling plate is enhanced, and the dissipation efficiency is improved, and the emission efficiency of the light-emitting diode may be higher.

### Exemplary Embodiment 2

The protection component and the light-emitting diode module of exemplary embodiment 2 are explained.

The difference between the exemplary embodiment and exemplary embodiment 1 lies in that external electrodes 16a and 16b are formed at the side of varistor portion 10 and ceramic substrate 12 in the exemplary embodiment, while external electrodes 16a and 16b are formed at the opposite side of the forming side of terminal electrodes 13a and 13b of ceramic substrate 12 in exemplary embodiment 1.

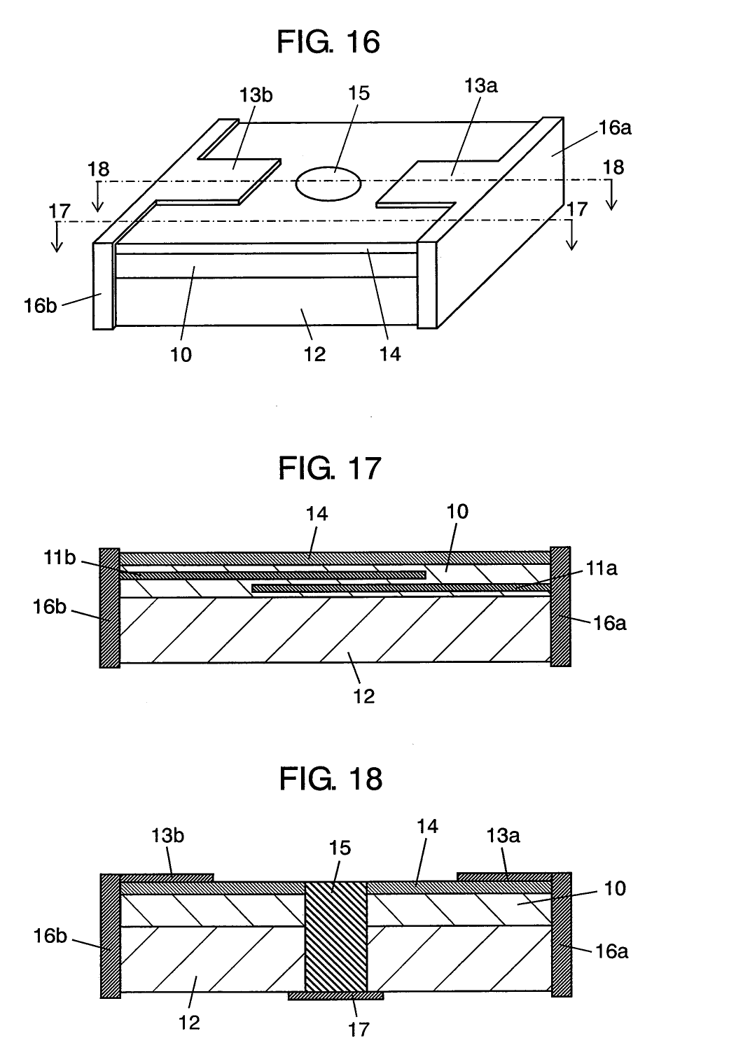

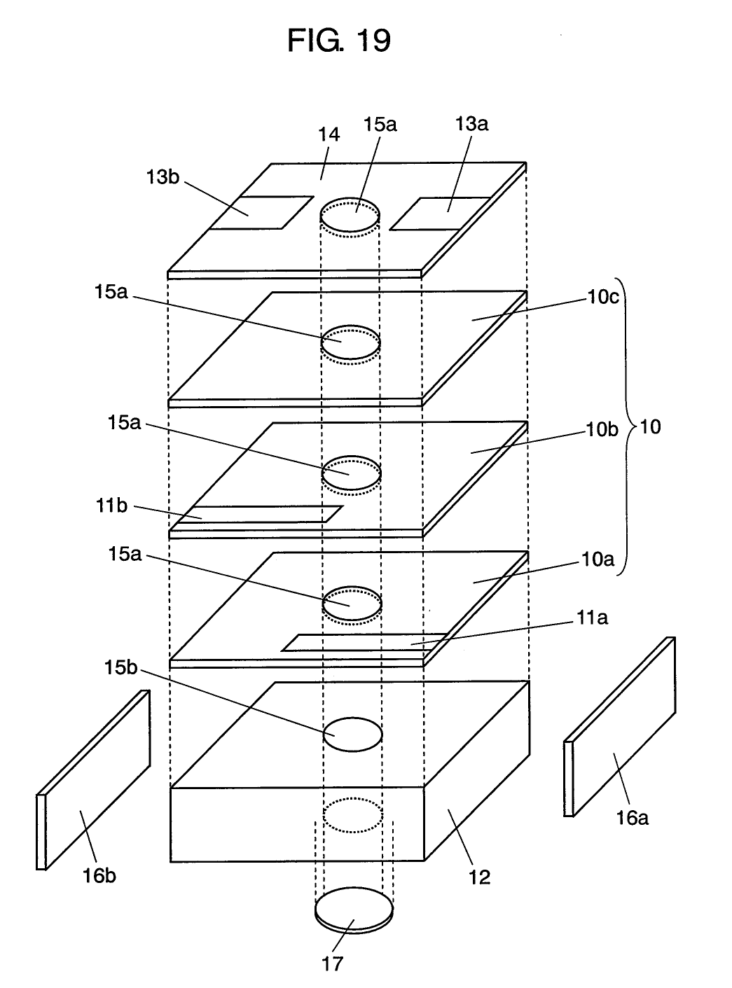

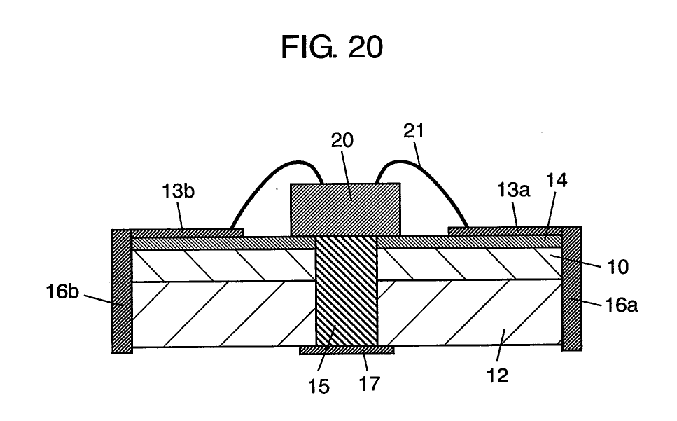

FIG. 16 is a perspective outline view of the protection component in the exemplary embodiment. FIG. 17 is a sectional view along line 17-17 of the protection component in the exemplary embodiment. FIG. 18 is a sectional view along line 18-18 of the protection component in the exemplary embodiment. FIG. 19 is a schematic perspective exploded view of the protection component in the exemplary embodiment. FIG. 20 is a sectional view of an electronic component module in the exemplary embodiment.

As shown in FIGS. 16 to 19, the protection component in the exemplary embodiment has, same as in exemplary embodiment 1, varistor portion 10 has three varistor layers 10a, 10b, and 10c, and internal electrodes 11a and 11b laminated alternately. The protection component in the exemplary embodiment also has a ceramic sintered body having ceramic substrate 12, varistor portion 10 formed on this ceramic substrate 12, and glass ceramic layer 14 laminated and formed thereon. On the surface of glass ceramic layer 14 of the ceramic sintered body, a pair of terminal electrodes 13a and 13b are provided, and a pair of external electrodes 16a and 16b are provided to be connected to internal electrodes 11a, 11b and terminal electrodes 13a, 13b. External electrodes 16a and 16b are provided at the side of the ceramic sintered body. Heat conducting portion 15 is further provided to penetrate through the ceramic sintered body vertically, and external heat conducting portion 17 is provided at the underside of the ceramic sintered body to be connected to heat conducting portion 15. Internal electrode 11a is electrically connected to external electrode 16a and terminal electrode 13a by drawing out to one end side of the ceramic sintered body. Internal electrode 11b is electrically connected to external electrode 16b and terminal electrode 13b by drawing out to other end side of the ceramic sintered body. When a light-emitting diode or other electronic component element is mounted on the protection component in the exemplary embodiment, heat conducting portion 15 on the upside of the ceramic sintered body is used as a mounting area for the electronic component element. Terminal electrodes 13a and 13b are electric connecting areas with the electronic component element.

As shown in FIG. 20, in the light-emitting diode module in the exemplary embodiment, light-emitting diode 20 is mounted on heat conducting portion 15 of the protection component in the exemplary embodiment. By using metal wire 21, one terminal of light-emitting diode 20 is electrically connected to terminal electrode 13a, and other terminal is electrically connected to terminal electrode 13b.

Therefore, the light-emitting diode module circuit in the exemplary embodiment is an equivalent circuit shown in FIG. 6 same as in exemplary embodiment 1.

As described herein, the protection component in the exemplary embodiment is composed by forming heat conducting portion 15 penetrating through the ceramic sintered body, on the ceramic sintered body formed integrally by laminating and sintering varistor portion 10 and glass ceramic layer 14 on ceramic substrate 12.

In the light-emitting diode module in the exemplary embodiment, light-emitting diode 20 is mounted on heat conducting portion 15 at the upside of the ceramic sintered body.

Therefore, by using heat conducting portion 15 of high heat conductivity, the heat generated from the mounted component may be released efficiently.

Further, by forming external heat conducting portion 17 to be connected to heat conducting portion 15 at the underside of the ceramic sintered body, the adhesion of the connection part mounted and connected on an external cooling plate or the like may be enhanced, and the heat generated from the mounted component may be released more effectively.

A manufacturing method of the protection component in the exemplary embodiment is explained by referring to FIG. 19.

A zinc oxide green sheet is prepared by using ceramic powder mainly composed of zinc oxide and an organic binder. A glass-ceramic green sheet is prepared by using glass-ceramic powder mainly composed of alumina and borosilicate glass, and an organic binder. At this time, the thickness of these green sheets was about 30 μm. The green sheets are baked, and varistor portion 10 is produced from the zinc oxide green sheet, and glass ceramic layer 14 is produced from the glass-ceramic green sheet.

As shown in FIG. 19, on the zinc oxide green sheet for varistor layer 10a, a conductor layer was formed as internal electrode 11a by using silver paste by screen printing method. Further, the zinc oxide green sheet for varistor layer 10b with conductor layer for internal electrodes 11b formed by a screen printing method using silver paste was laminated thereon. Further thereon, the zinc oxide green sheet was laminated as varistor layer 10c, and a laminated body was fabricated as varistor portion 10. Further thereon, conductor layers were formed as terminal elements 13a and 13b by using silver paste by screen printing method, and the glass-ceramic green sheet was laminated as glass ceramic layer 14, and a laminated body consisting of varistor portion 10 and glass ceramic layer 14 was fabricated. At this time, the conductor layers for forming internal electrodes 11a, 11b, and the conductor layers for forming terminal electrodes 13a, 13b were formed by avoiding an area for forming heat conducting portion 15a in a later process as shown in FIG. 19.

Further, a through-hole was formed by a puncher or the like to penetrate through varistor portion 10 and glass ceramic layer 14 of this laminated body, and the through-hole was filled with silver paste. This silver paste applied in the through-hole becomes heat conducting portion 15a after baking.

On the other hand, as ceramic substrate 12, an alumina substrate having through-holes provided at the specified positions was prepared, and the through-holes in the alumina substrate were filled with silver paste. Further, on one side of the alumina substrate, a conductor layer for forming external heat conducting portion 17 was formed by using silver paste by screen printing method. The silver paste applied in the through-hole becomes heat conducting portion 15b after baking. Heat conducting portions 15a and 15b are baked and integrated, and heat conducting portion 15 is formed.

On the alumina substrate having through-holes filled with silver paste and formed with the conductor layer, a laminated body of varistor portion 10 and glass ceramic layer 14 filling the through-hole with silver paste was adhered, and a laminated body block was formed. The thickness of the alumina substrate was about 180 μm, and the thickness of the conductor layer was about 2.5 μm. The silver content of the silver paste used in the heat conducting portion was 85 wt. %, and the diameter of the heat conducting portion was 300 microns. The pattern of the printed conductor layer was formed of a multiplicity of vertical and lateral shapes arranged so as to be as shown in FIG. 19 after being cut.

The laminated body block was heated in atmosphere to remove the binder, and was further heated up to 930° C. and baked in atmosphere, and an integrated sintered body was obtained. The sintered body of the laminated body block was cut and separated into individual pieces of laminated body in specified dimensions. Silver paste was applied to the side face of the sintered body, and waste heated in atmosphere at 900° C., and external electrodes 16a and 16b were formed. Successively, by plating the positions of the external electrodes 16a, 16b and terminal electrodes 13a, 13b with nickel and gold, the protection component conforming to the exemplary embodiment was obtained as shown in FIGS. 16 to 18.

The manufactured protection component in the exemplary embodiment was about 2.0 mm in length direction dimension, about 1.25 mm in width, and about 0.3 mm in thickness. Varistor voltage V_{1mA} between external electrodes 16a and 16b, that is, the voltage in flow of current of 1 mA was 27 V.

In the manufacturing method of the exemplary embodiment, as explained in the method of forming terminal electrodes 13a, 13b, heat conducting portion 15, and external heat conducting portion 17, when forming varistor portion 10 and glass ceramic layer 14 on the alumina substrate, they were baked simultaneously. Instead, for example, a sintered body is formed in the first place by disposing varistor portion 10, glass ceramic layer 14, heat conducting portion 15, and via conductors for connection 19a and 19b on the alumina substrate. Then, the conductor layer of silver paste for forming terminal electrodes 13a and 13b is formed on glass ceramic layer 14, and the through-hole is filled with silver paste as heat conducting portion 15. The conductor layer of silver paste for forming external conductor part 17 is formed on one side of the alumina substrate, and they are baked. Subsequently, terminal electrodes 13a and 13b, heat conducting portion 15, and external heat conducting portion 17 may be formed.

In the case of such process, the sintered body may be either a block of a multiplicity of vertical and lateral pieces arranged, or an individual sintered body, but it is preferred to use a block of sintered bodies from the viewpoint of production performance.

To compare with the exemplary embodiment, a comparative example of protection component was fabricated, as shown in FIG. 7, same as exemplary embodiment 1. What the protection component of the comparative example differs from the protection component of the exemplary embodiment lies in that heat conducting portion 15 and external heat conducting portion 17 are not provided.

Referring now to FIG. 20, a manufacturing method of light-emitting diode module in an exemplary embodiment of the present invention is explained.

On heat conducting portion 15 of the protection component in the exemplary embodiment, blue light-emitting diode 20 is mounted by die-bonding by using a conductive adhesive (not shown). Then, by wire bonding method, one terminal of blue light-emitting diode 20 and terminal electrode 13a are connected by means of metal wire 21, and other terminal of blue light-emitting diode 20 and terminal electrode 13b are connected by means of metal wire 21. Blue light-emitting diode 20 was covered with resin mold (not shown), and a light-emitting diode module of the exemplary embodiment was manufactured as shown in FIG. 20.

To compare with the exemplary embodiment, using the protection component of the comparative example, a blue light-emitting diode element was mounted on the protection component of the comparative example, and a light-emitting diode module of the comparative example was manufactured. The sectional view of the light-emitting diode module of the comparative example is same as FIG. 20, except that heat conducting portion 15 and external heat conducting portion 17 are not provided.

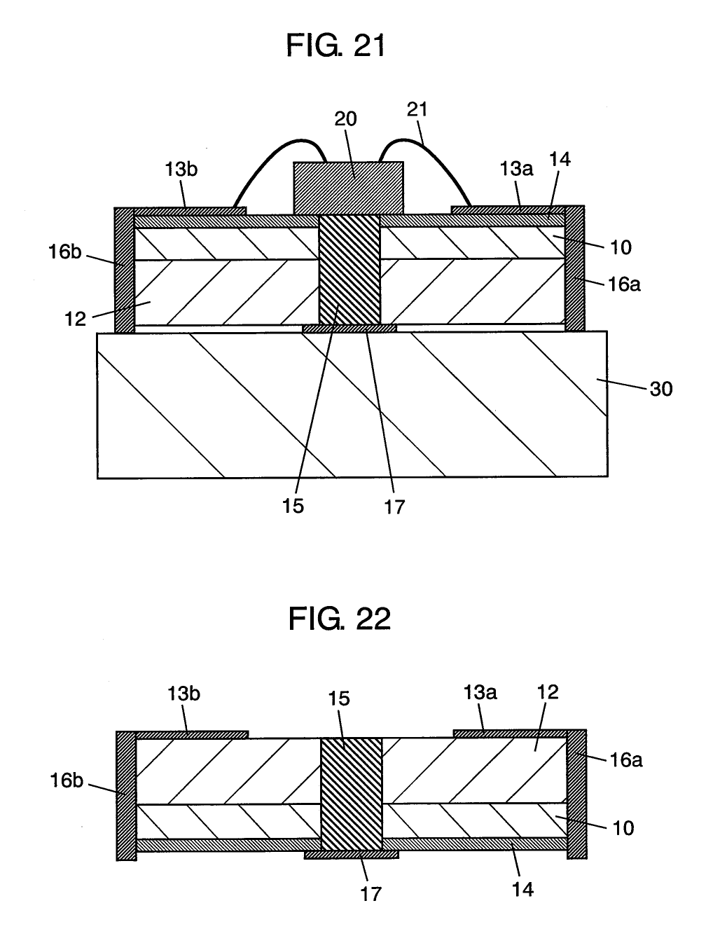

In the light-emitting diode module of the exemplary embodiment and the light-emitting diode module of the comparative example, the heat dissipating performance was evaluated in the following procedure. Using these light-emitting diode modules as shown in FIG. 21 (in which the comparative example is not shown), mounting on cooling plate 30, the diode was illuminated by applying an electric power of 1 W on blue light-emitting diode 20, and the electric power was supplied continuously until the temperature of blue light-emitting diode 20 was saturated. At this time, the temperature of blue light-emitting diode element 20 was about 100° C. in the light-emitting diode module of the comparative example, and was about 85° C. in the light-emitting diode module of the exemplary embodiment. Thus, the light-emitting diode module in exemplary embodiment is known to be superior in dissipation performance as compared with the light-emitting diode module of the comparative example.

Incidentally, when the temperature of blue light-emitting diode 20 was saturated, the light intensity was measured in both samples, and supposing the light intensity ratio of the light-emitting diode module of the comparative example to be 100, the light intensity ratio of the light-emitting diode module of the exemplary embodiment was about 110. Hence, since the light-emitting diode module of the exemplary embodiment is superior in dissipation performance, it is known that decline of emission efficiency of the light-emitting diode can be prevented.

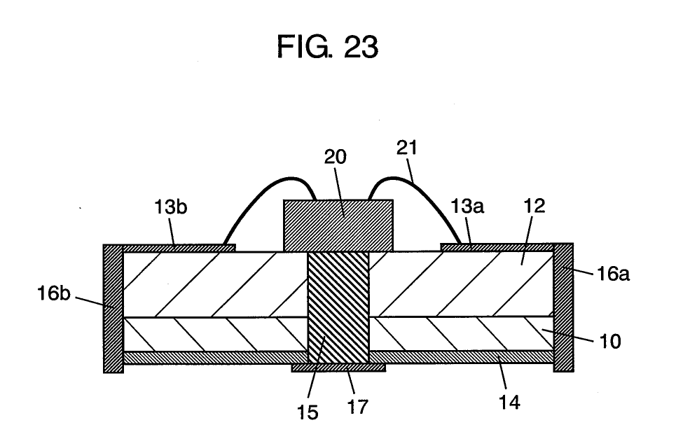

In the protection component of the exemplary embodiment, terminal electrodes 13a and 13b are provided on the surface of glass ceramic layer 14 of the ceramic sintered body, but in the protection component of third example of the exemplary embodiment, as shown in FIG. 22, terminal electrodes 13a and 13b may be formed at the opposite side of the forming side of glass ceramic layer 14 of the ceramic sintered body. FIG. 23 is a sectional view of the light-emitting diode module using the protection component of this third example. In the protection component and light-emitting diode module of the third example, the same effects as in the exemplary embodiment are obtained.

In addition, by using a white substrate of alumina or the like as ceramic substrate 12, when light-emitting diode 20 is mounted as electronic component element, since the surrounding of light-emitting diode 20 is a white color high in reflectivity, the emission efficiency of the light-emitting diode may be further enhanced.

As explained herein, the protection component of the present invention is small in size and high in strength, incorporating a varistor function, and a protection component is realized, and moreover since a heat conducting portion is provided, the heat generated from the mounted component may be released efficiently.

In the electronic component module of the present invention, since the light-emitting diode and other electronic component elements are protected from electrostatic discharge pulses by the varistor portion, the resistance to electrostatic discharge pulses is excellent, the heat generated from the electronic component element is released efficiently by the heat conducting portion, and the dissipation performance is excellent, the emission efficiency is superior, and it is small and practical.

What is claimed is:

1. An electrostatic discharge protection component comprising a ceramic sintered body having a ceramic substrate, a varistor portion formed by laminating a varistor layer and an internal electrode alternately on the ceramic substrate, and a glass ceramic layer formed on the varistor portion, a par of terminal electrodes provided on the ceramic sintered body, a pair of external electrodes connected to the internal electrode and the terminal electrodes, and a heat conducting portion penetrating through the ceramic sintered body.

2. The electrostatic discharge protection component of claim 1, wherein the terminal electrodes are provided on the surface of the glass ceramic layer of the ceramic sintered body.

3. The electrostatic discharge protection component of claim 1, wherein the terminal electrodes are provided on the opposite side of the forming side of the glass ceramic layer of the ceramic sintered body.

4. The electrostatic discharge protection component of claim 1, wherein the external electrodes are provided on the opposite side of the forming side of the terminal electrodes of the ceramic sintered body.

5. The electrostatic discharge protection component of claim 1, wherein the varistor portion is provided on both sides of the ceramic substrate.

6. The electrostatic discharge protection component of claim 1, wherein an external heat conducting portion for connecting to the heat conducting portion is provided on the opposite side of the forming side of the terminal electrodes of the ceramic sintered body.

7. An electronic component module, wherein an electronic component element is mounted on the heat conducting portion of the electrostatic discharge protection component of claim 1, and the terminals of the electronic component element and the terminal electrodes of the electrostatic discharge protection component are connected electrically.

8. The electronic component module of claim 7, wherein the electronic component element is a light-emitting module.
